(19) United States
(12) Patent Application Publication
(10) Pub. No.: US 2013/0218541 A1
(43) Pub. Date: Aug. 22, 2013

(54) COMPUTERIZED PAIN ASSESSMENT TOOL

(71) Applicant: William H. Dodson, Odessa, TX (US)

(72) Inventor: William H. Dodson, Odessa, TX (US)

(21) Appl. No.: 13/847,287

(22) Filed: Mar. 19, 2013

Related U.S. Application Data
(63) Continuation-in-part of application No. 13/246,664, filed on Sep. 27, 2011.
Application No. 13/246,664 is a continuation of application No. 11/702,461, filed on Feb. 5, 2007, now Pat. No. 8,046,241.

(51) Int. Cl. G06F 19/00

(52) U.S. Cl. CPC G06F 19/3437
USPC 703/2

(57) ABSTRACT

A computerized pain assessment system, method, and non-transitory computer readable medium are described. A screen that includes a human body replica containing a known number of pixels is displayed, and then an area is indicated to represent a pain area. An indicated number of pixels representing the pain area divided by the known number of pixels defines a pain coverage. A pain intensity is indicated on a first scale depicting the pain intensity between minimum pain and maximum pain. The first scale corresponds to a first numeric scale for measuring the pain intensity. A depth of pain is indicated on a second scale depicting the depth of pain between superficial and deep. The second scale corresponds to a second numeric scale for measuring the depth of pain. An objective pain value is computed from the pain coverage multiplied by the pain intensity on the first numeric scale and multiplied by the depth of pain on the second numeric scale. The objective pain value is displayed.

### CROSS REFERENCE TO RELATED APPLICATIONS

This application is a continuation-in-part and claims the benefit of U.S. patent application Ser. No. 13/246,664, U.S. App. Pub. 2013/0018275, entitled COMPUTER PAIN ASSESSMENT TOOL, by William H. Dodson, filed Sep. 27, 2011, the entire contents of which are incorporated herein by reference; and the application Ser. No. 13/246,664, is a continuation of U.S. Pat. No. 8,046,241, to Dodson, filed Feb. 5, 2007.

### FIELD OF THE PRESENT DISCLOSURE

The present invention relates to assessing human pain, and more particularly to computerized pain assessment tools.

### BACKGROUND

Bodily pain is a rather subjective, complex phenomenon consisting of a sensorial perception, sometimes revealing a potential or real tissular lesion, and the affective response, such as crying or verbal outburst, provoked by this sensorial perception. As bodily pain sensation is also psychic, objective evaluation thereof is difficult.

Pain evaluation during clinical examination of patients includes evaluation of pain sensitivity and is generally performed by means of palpation of skin or underlying tissues (for example muscles), or by means of other more or less reliable methods. Both the response to manual palpation and evaluation of pain sensitivity from such a response is complex and often unreliable. Verbal reports of the patient are generally unreliable because such reports depend on the patient's recollection of pain and because bodily pain may widely vary within the same day and from one day to another. It is well known that retrospective symptom data, including pain, are notoriously inaccurate.

Clinical methods include well known paper pain mapping of a pain area and visual analogue scale of the pain intensity. In these methods, patients are presented with paper images of the anterior and posterior of the human body and a finite length scale on paper for indication of no pain or superficial pain at one end to extreme pain at the other end, perhaps on a scale of one to ten or zero to one hundred. The patient colors or shades in or indicates the entire area where the pain occurs.

Paper pain mapping includes multiple categories of similar pain words from which the patient checks his or her particular pain associated with the area identified on the drawing of a human anterior and posterior. Most paper pain mapping use various symbols of shading or indicating, such as a series of x x x x or o o o o or ̂ ̂ ̂ ̂, but do not allow for several different type pains in the same area of the body. The patient may also mark the frequency of recurrence of the pain. For patients with extensive pain areas to shade or indicate, such a task, using mapping symbols, is tedious and time consuming. If the human body replica is too small, the patient may not be able to shade or indicate the exact area of pain.

Using the paper pain mapping and the visual analog scale of intensity is difficult, if not impossible, to quantify changes in pain perception partly because the area of pain as mapped and the intensity on the visual analog scale are not correlatable. Lavigne et al., U.S. Pat. No. 5,533,514 describes an algometer system where a representation of a patient's body is displayed on a computer screen and one or more points are marked for pain sensitivity measurement, then a pressure algometer applies pressure at the selected points to the patient's body until the patient perceives the pain threshold of pain (tolerance) and pushes a stop button which holds the pressure applied. The patient also selects a pain intensity value on a visual analog scale. These values are stored in the patient's records. Lavigne et al., in a later U.S. Pat. No. 5,592,947, discloses improvements over the earlier patent by providing a method and an algometer designed for facilitating intensification of the applied pressure at a constant adjustable rate. The foregoing patents to Lavigne et al., provide for pressure-pain threshold data where palpation examination is more of a sensitivity to pain analysis. It appears from the early oral and palpation examinations and even paper pain mapping and visual analog scales system, which are heavily subjective, that there is a need for less subjective and more objective clinical inputs from the patient concerning when, where, what and how his or her sensorial perception of pain occurs.

### SUMMARY

The present invention relates to a system, method, and non-transitory computer readable medium for patients suffering from bodily pain to communicate more objectively as to the pain location, type, area, center, depth, and intensity using a series of computer screens presenting an anterior and posterior of a human body replica. The patient shades or indicates the area on the human body replica where their pain occurs, identifies a center of the pain, moves a slider on the intensity of pain scale to the perceived relative intensity of pain, checks the type of pain selected that best describes such pain, and moves a slider on the depth of pain scale to the perceived relative deepness of the pain. After the patient has completed entering the last data, the patient is presented with a screen indicating the pain intensity in color matching the patient's choice, the type of pain by the color pattern, and the pain area of the body covered by the color pattern with a different pattern identifying the center of pain, and a prompt that asks the patient if the displayed screen accurately describes the pain. The patient is also provided with options to change selections, add another pain area and go to the next screen for a new assessment, or exit and finish to save the patient's data.

Another feature of the invention includes modifications of the system to accommodate the clinician or physician definitions of pain, as well as, posing customizable survey questions with multiple choice answers.

In another aspect of the invention, the anterior and posterior of the body replica display has a finite number of pixels, hence, the shading or indicating an area of the body replica by a patient allows calculation of the fraction or percent of the body experiencing pain. The system is designed such that no shading or indicating of any area outside the body replica is recorded. Once the patient has indicated the pain intensity and the depth of the pain, the system may calculate an objective pain value by multiplying the percent of the body experiencing pain by another objective measure, such as a scaled pain intensity and/or a scaled depth of pain. After completion of the pain assessment by the patient, including the area, center, type, intensity, and depth of pain, a full report of the patient's discomfort is available. Such computer retained pain assessment is available for future comparison as to therapeutic pain reduction for the patient. Upon the patient's completion of the pain assessment, the computer generates a printable report with the pain type, area, center, depth, and intensity displayed on the body replica and the calculated objective pain value for the doctor or clinician.

The present invention provides a simple, more accurate communication by a patient for a doctor or therapist of his or her discomfort by presenting the patient with, in the kiosk or interactive mode, a computer display of the anterior and posterior of a body replica on which the patient shades or indicates his or her pain area on the body replica and identifies the center of the pain, then a computer display with a color scale (color spectrum) graduated from blue (little, minimum, or no pain) to red (worst or maximum pain) for the patient to select a position on the scale that best indicates the pain intensity, a check-the-box pain type selector, and a depth of pain scale (gray scale) graduated from white to black for superficial to bone deep indication of pain. The pain types for selection by the patient may be preselected by the doctor or therapist, and an additional display or screen may present several multiple choice survey questions and answers as desired. The patient may repeat the shading and selecting for each different area, center, pain intensity, type, and depth in order to fully describe his or her discomfort. Next, the computer screen displays the body replica with the pain area designated with various symbols coded for the type of pain, center of pain, and colored for both the pain intensity and the depth of pain for the patient to review and revise his or her pain assessment or activate finish to save such data and end the pain assessment session.

### BRIEF DESCRIPTION OF THE DRAWINGS

Drawings of the preferred embodiments of the present disclosure are attached hereto so that the embodiments of the present disclosure may be better and more fully understood:

FIG. 1 is a sample computer screen of the anterior and posterior of a human figure enclosed in a touch screen region for painting or shading or indicating an area of pain and a center of pain;

FIG. 2 is a sample computer screen of a color spectrum scale for pain intensity, a check box selection of pain type, and a gray scale for depth of pain;

FIG. 3 is a sample computer screen of the anterior and posterior of a human figure where horizontal bars indicate the type of pain and the color of the bars indicates the intensity of pain;

FIG. 4 is similar to FIG. 3 with a different pain type and intensity for the same patient;

FIG. 5 is a block diagram illustrating the sequence of documenting a single pain area;

FIG. 6 is a sample survey with customized questions and answers;

FIG. 7 is a sample screen printable report as to a first area of pain;

FIG. 8 is a sample screen printable report as to a second area of pain; and

FIG. 9 is a sample printable report summary of pain from FIGS. 7 and 8 with an Objective Pain Value calculated.

### DETAILED DESCRIPTION THE INVENTION

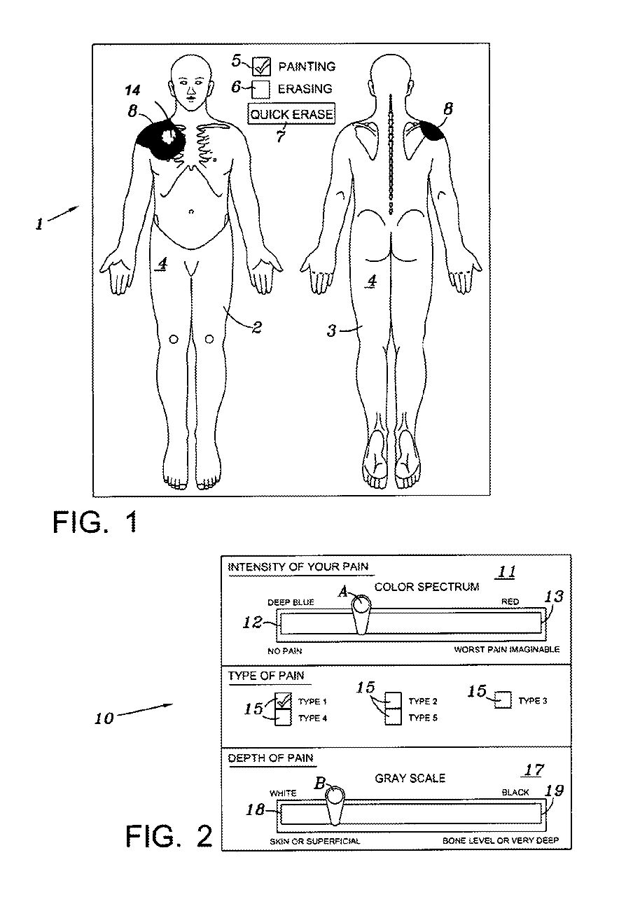

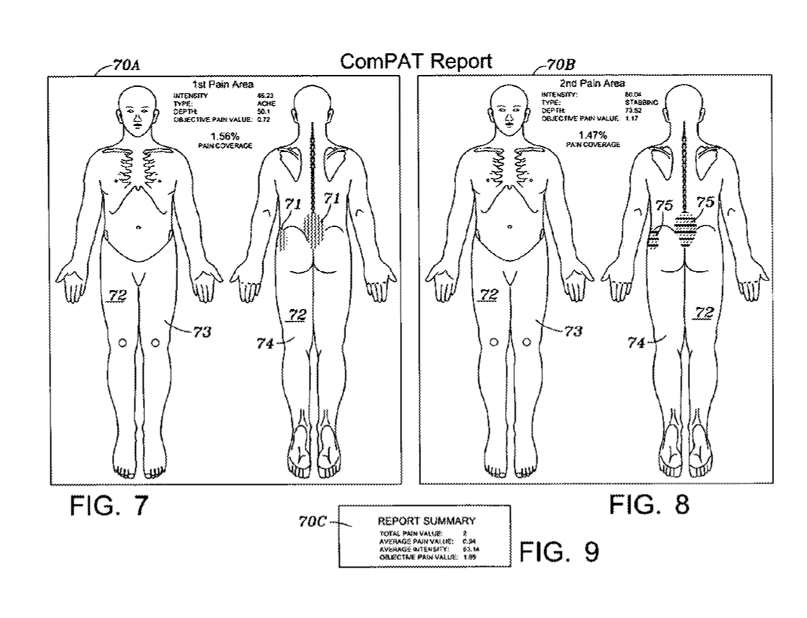

Referring now to the drawings and in particular to FIGS. 1 through 4, portions of the interactive display for patient inputs are displayed. The patients are guided through FIGS. 1 through 4 by instruction on each successive screen displays 1, 10, 20, and 30, and further assisted by selecting a help screen on a navigation bar, as well as, selecting a prior screen or a next screen on the navigation bar when applicable. In order to illustrate the patient's computerized pain assessment, the help aid on the navigation bar and on screen instructions are not shown in FIGS. 1 through 4 and FIG. 6. Likewise, for simplicity of illustration only, FIGS. 7, 8, and 9, screens 70A, 70B and 70C, respectively, do not display the patient information such as name, social security number, gender, date of birth, physical data, medications, etc., although this information is provided on an actual report.

Once a clinician or physician has recorded all of the patient's personal data and medical history, the computerized pain assessment tool is placed in a kiosk interactive mode which prevents the operating system from presenting any misleading or distracting information on the computer display for the patient. The patient is seated in front of the computer display for a computer implementing the computerized pain assessment tool, which may be a desktop or tablet computer, where a sequence of computer screens are to be displayed. The patient will be briefly instructed on the use of the computerized pain assessment tool (ComPAT™) and told to follow the instructions on each screen in sequence.

With particular reference to FIG. 1, the computer screen area includes a body outline that has a finite number of pixels. The patient taps or clicks the “Painting” box 5 to begin painting by shading or indicating an area of pain 8 on an anterior 2 and a posterior 3 of a human body replica 4 with a touch screen marker to record the area of pain 8. Only the pixels confined within the human body replica 4 can be shaded or indicated. The patient may check the “Erasing” box 6 to lessen the area of pain 8 or check the “Quick Erase” box 7 to delete the shaded or indicated part of the area of pain 8 on the human body replica 4, and start anew. As part of the process of shading or indicating the area of pain 8, the patient has the option of identifying a center of pain 14 by either erasing some of the shaded or indicated pixels where the center of pain 14 is located within the area of pain 8, by shading or indicating the center of pain 14 with a different color, or by some other means. The center of pain 14 may or may not be located close to the geographic center of the area of pain 8. The center of pain 14 may be depicted by an icon that gives the appearance of being three dimensional. The patient identifying the center of pain 14 may assist a doctor or therapist in diagnosing potential causes of the pain. Once the patient completes the painting of the area of pain 8, the percentage of the human body replica 4 defined by the area of pain 8 is determined by the number of shaded or indicated pixels divided by the total number of pixels that make up the human body replica 4, multiplied by 100 to be expressed as a percentage, herein sometimes referred to as pain coverage. Identifying the center of pain 14 does not remove the pixels identified in the area of pain 8 as the center of pain 14 from the number of shaded or indicated pixels for the purpose of calculating the pain coverage.

After the patient completes painting the area of pain 8 on the screen 1, the patient clicks “next” on the navigation bar, which is not shown in FIG. 1. The patient is presented with the screen 10 in FIG. 2 which includes a color spectrum 11 for selecting pain intensity from a deep blue 12 indicating minimum or no pain to a red 13 indicating the worst or maximum pain imaginable. The patient moves a pointer A along the color spectrum 11 or touches or clicks on the color spectrum 11 at a point to position the pointer A at the color best representing the pain intensity.

The type of pain on screen 10 of FIG. 2 includes five check boxes 15. Each check box 15 represents a different type of pain. Type 1 through type 5 would actually be described by words associated with pain on the screen 10. The computerized pain assessment tool may be preprogrammed by a technician or clinician for each patient depending on the types or kind of pain a patient might expect from the injury, medical procedure, or malady the patient experienced, such as ache, stabbing, burning, throbbing, pinching, sharp, radiating, etc. The well-known McGill Pain Questionnaire suggests many such types of pain.

The depth of pain is displayed as a gray scale 17 on screen 10 for selecting pain depth from a white 18, indicating skin or superficial, to a black 19, indicating bone level or very deep. The patient may move a pointer B along the gray scale 17 or touch the gray scale 17 to position the pointer B anywhere from the white 18 to the black 19. The data documented on the screen 10 is for the area of pain 8 in FIG. 1.

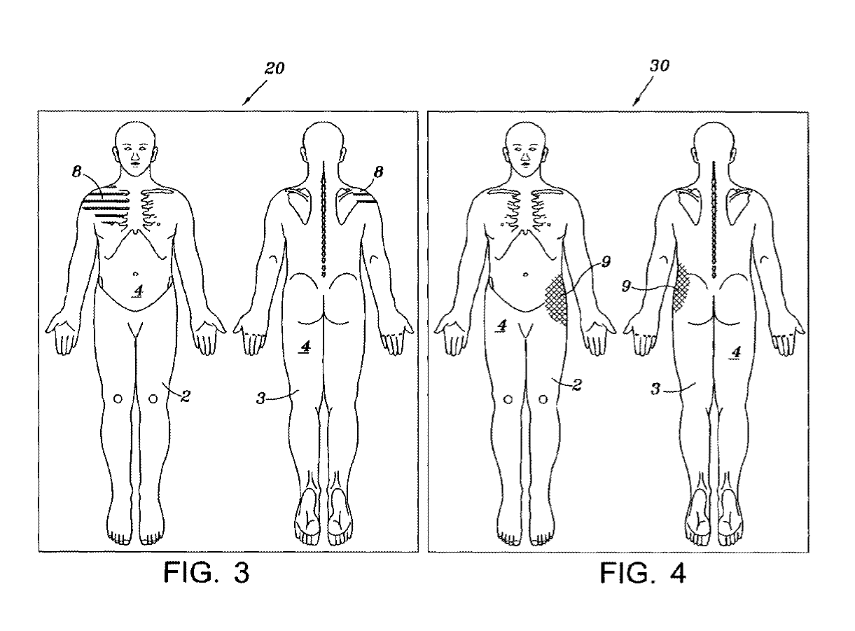

Further, the patient can click “next” on the navigation bar, which is not shown in FIG. 2, be presented with the screen 20 in FIG. 3, and be asked to confirm the representation of the patient's pain. The screen 20 includes the anterior 2 and the posterior 3 of the human body replica 4 as depicted in FIG. 1, where the area of pain 8 is delineated by horizontal bars depicting the type of pain and in green from the color spectrum representing the pain intensity. In the on-screen instructions, which are not shown in FIG. 3, the patient is asked to confirm the depiction of their pain by checking the “yes” box or the “no” box, which are not shown. If the “no” box is checked, the pain shading or indicating screen 1 of FIG. 1 will reappear so the patient can review and modify the pain area previously shaded or indicated, then click “next” to bring up the screen 10 of FIG. 2 to review and modify the description of the pain. When finished with such review and modification, if any, the patient clicks “next” and the confirm pain screen 20 of FIG. 3 reappears. The patient may check “yes” to confirm that the screen 20 accurately describes the pain. If the “yes” box is checked, the patient is asked if there are other pain areas to map and/or describe, and the patient may check an additional “yes” box or an additional “no” box, which are not shown. If the patient checks the additional “yes” box, another screen similar to the screen 1 of FIG. 1 appears for shading or indicating a second pain area, then, after shading or indicating the second pain area, the patient may click “next” on the navigation bar and another screen, like the screen 10 of FIG. 2 may appear for the patient to describe the pain. This second description is for the second pain area. After describing the second pain area, the patient clicks “next” on the navigation bar, and is then presented with another screen similar to the screen 30 in FIG. 4 to confirm the depiction of the second pain.

Upon viewing the confirm pain screen 20 of FIG. 3 for the first pain area or the screen 30 of FIG. 4 for the second pain area, if the patient checks the “no” box for the first pain area, the screen 1 of FIG. 1 reappears for changes, then in sequence the patient clicks “next” and the screen 10 of FIG. 2 reappears for changes, then the screen 20 of FIG. 3 reappears to confirm the depiction of the pain, as modified. The first pain must be confirmed as depicted by the screen 20 of FIG. 3 before a second pain area can be selected.

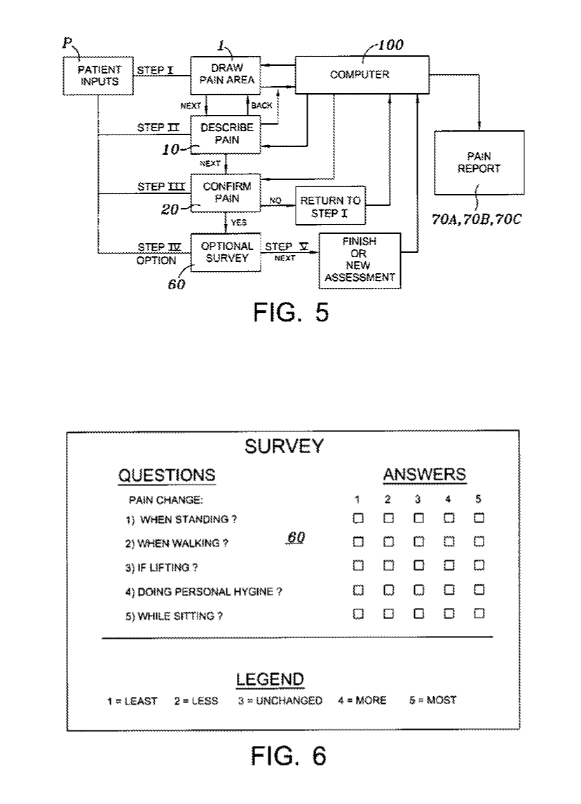

Referring now to FIG. 5, the block diagram delineates the sequences or steps that a patient P performs in describing his or her pain with the computerized pain assessment tool. For simplicity, FIG. 5 illustrates the sequences of interactive screens for the patient P with a single area, type, intensity and depth of pain. Upon initiation or activation of a computer 100, the patient P observes the screen 1, which is depicted in FIG. 1, and begins Step I, shading the area of pain 8 on the anterior 2 and the posterior 3 of the human body replica 4. When the patient P is satisfied with the screen 1 as modified by his or her shading or indicating, the patient P starts Step II by clicking “next,” and the computer 100 display the screen 10 for the patient P. In Step II, the patient P responds by selecting, in any order, the intensity of pain by moving the pointer A by dragging to or clicking on the color spectrum 11 between the pain intensity colors 12 and 13 on the screen 10, the type of pain by checking the appropriate check boxes 15 indicating the pain experienced by patient P; and the depth of pain by moving the pointer B by dragging to or clicking on the gray scale 17 between the depth of pain colors 18 and 19.

The patient P clicks “next” to begin Step III, the computer 100 processes the data input by the patient P from Step I and Step II, and the computer displays the screen 20 for confirmation of the depiction of the pain. The patient P either checks box “yes” or box “no” to confirm or not to confirm, respectively, the current screen's depiction of the pain.

When the patient P checks “no,” the computer 100 displays screen 1 as originally completed by the patient P for further modification. When the patient P clicks “next,” the computer 100 displays the screen 10 as originally completed by patient P. When the patient P clicks “next,” the computer 100 processes the revision made in Step I and Step II, and displays a revised screen 20 for confirmation as revised.

When the patient P clicks “yes” and then “next” to confirm the current screen's depiction of the pain, the computer 100 begins Step IV by displaying the survey screen 60 depicted in FIG. 6 and referenced below. When the patient P completes or skips the screen 60 and clicks “next”, the computer 100 begins Step IV by displaying a choice for patient P to either select “finish,” indicating that the assessment is completed and requesting to save the data or select “new assessment,” requesting for all patient P data to be erased and for screen 1 to reappear for Step I to begin anew. Upon completion of the painting the area of pain, describing the pain, confirming the accuracy of the pain depicted, and the patient P clicking “finish,” the computer 100 processes and stores the patient P data and generates a pain report as illustrated in FIG. 7 for a first pain area, FIG. 8 for a second pain area, and FIG. 9 for a report summary.

If the patient is satisfied with the depiction of the pain in the screen 30 in FIG. 4, the patient clicks “next,” and survey questions appear on the screen 60 of FIG. 6. Although the screen 60 depicts only five survey questions, any number of survey questions may be displayed to the patient. The questions are customized by preselecting a group of question to be displayed out of a much larger group of possible questions before the patient begins the pain survey.

Instead of simply using one of the hundreds of surveys available in the medical and psychological fields, a doctor or therapist may use a survey builder tool to select and compile the questions for the screen 60. A user of the survey tool builder can select from other survey's questions, add text to create the user's own questions, add possible answers to the questions, and assign points to each of the possible answers to be totaled for diagnostic purposes. The survey tool builder enables a user to create a customized survey.

The answers to the customized survey are entered by clicking the corresponding check “box” with the possible answers which, like the questions, are preselected before the patient begins the pain survey. The actual programmed answers would appear above each column of boxes instead of the numbers or as a legend for numbers 1-5 in the screen 60. If the patient does not want to complete the pain survey, the patient checks “next” and a screen appears with the options to go “back” to a previous screen, begin a “new assessment” to start completely over, or “finish.” The computerized pain assessment tool saves the data when the patient clicks “finish” on the navigation bar, which is not shown.

FIG. 7, FIG. 8, and FIG. 9 depict reports created by the computerized pain assessment tool. The reports may indicate the intensity, type, depth, center, and pain coverage (percentage of area) for the first and second pain areas. The pain intensity may be a number from zero to one hundred represented on the color spectrum from blue to red, respectively. The depth of pain may be a number from zero to one hundred represented on the gray scale from white to black, respectively. The reports may also include the Object Pain Value calculated from any combination of the pain coverage, the paint intensity, and the depth of pain.

The Objective Pain Value is a number that may be devised from the fraction of the number of pixels shaded or indicated on the human body replica 4 over the total number of pixels forming the human body replica 4. This fraction may be multiplied by the pain intensity which is a number from zero to one hundred represented on the color spectrum scale from deep blue to red, respectively, and/or by the depth of pain which is a number from zero to one hundred represented on the gray scale from white to red, respectively, to arrive at the Objective Pain Value. For example, referring to FIG. 7, screen 70A (ComPAT™ Report), the pain intensity was 46.23 on a scale of 0 to 100 and the pain coverage percent was 1.56% (pixels shaded or indicated divided by total body replica pixels) with the multiplication result of the pain intensity and the pain coverage equaling an Objective Pain Value of 0.72 (seventy-two hundreds). To provide a more useful number, the pain coverage fraction could be multiplied by 100, which would result for this example, an Objective Pain Value of 72. In another example, the pain intensity was 46.23 on a scale of 0 to 100, the depth of pain was 39.78 on a scale of 0 to 100, and the pain coverage percent was 1.56% (pixels shaded or indicated divided by total body replica pixels) with the multiplication result of the pain intensity, the depth of pain, and the pain coverage equaling an Objective Pain Value of 29. In yet another example, the pain intensity was 46.23 on a scale of 0 to 100 and the depth of pain was 39.78 on a scale of 0 to 100, with the multiplication result of the pain intensity and the depth of pain equaling an Objective Pain Value of 1,839 out of a maximum possible 10,000. The computerized pain assessment tool may offer doctors and therapists the option of selecting which pain factors to multiply together to produce a specific type of Objective Pain Value of interest to the doctor or the therapist.

Referring to FIG. 7, screen 70A is the first page of the ComPAT™ Report for the first pain area 71 identified by vertical wavy lines on the human body replica 72. The first page of a report would include patient information such as name, social security number, gender, date of birth, address, telephone, etc., as well as, height, weight, referral, surgery and/or injury date. For clarity this data is not presented in FIG. 7, screen 70A.

FIG. 8 depicts screen 70B as the second page of the report for the second pain area 75 identified by horizontal bars with interspersed slashes on the human body replica 72. Indicia 71 marking the first pain area design indicates the type of pain (ache) and the color of the design indicates the pain intensity on a scale of 0 to 100 (46.23). Likewise, indicia 75 marking the second pain area design indicates the type of pain (stabbing) and the color of the design represents the intensity (80.04). The legends on the screens 70A and 70B include the pain intensity, the pain type, the pain coverage (percentage) and the Objective Pain Value from multiplying the pain coverage by the pain intensity.

The legend on screen 70C depicted in FIG. 9 combines the information on the legends on screens 70A and 70B to provide the total pain value, the average pain value, the average pain intensity, and the Objective Pain Value from multiplying the pain coverage by the pain intensity.

For purposes of clarity in the FIGS. 1 through 4 and FIG. 6, the instructions on the screens 1, 10, 20, 30 and 60 for the patient to follow, as well as, the navigation bar with the options “Help,” “Back,” “Next,” and “Finish” are not illustrated. These things are described as needed, and are not shown in the drawing to avoid complexity in illustrating the patient's pain assessment.

Although the invention has been shown and described with respect to a best mode embodiment thereof, it should be understood by those skilled in the art that various changes, omissions, and additions may be made to the form and detail of the disclosed embodiment without departing from the spirit and scope of the invention, as recited in the following claims.

1. A system for computerized pain assessment comprising:
a computer;
a memory;
a computer display device;
a user input device; and
a computer program stored in the memory and executed by the computer to:
display a screen that includes a human body replica containing a known number of pixels via the computer display device;
indicate an area of the human body replica representing a pain area based on information provided by the user input device, wherein an indicated number of pixels of the area of the human body replica representing the pain area divided by the known number of pixels in the human body replica defines a pain coverage;
indicate a pain intensity on a first scale depicting the pain intensity between minimum pain and maximum pain based on information provided by the user input device, wherein the first scale corresponds to a first numeric scale for measuring the pain intensity;
indicate a depth of pain on a second scale depicting the depth of pain based on information provided by the user input device, wherein the second scale corresponds to a second numeric scale for measuring the depth of pain;
compute an objective pain value from the pain coverage multiplied by the pain intensity on the first numeric scale and multiplied by the depth of pain on the second numeric scale; and
display the objective pain value via the computer display device.

2. The system of claim 1, wherein the first scale represents the pain intensity on a color spectrum scale from blue to red, and corresponds to the first numeric scale of zero to one hundred, respectively

3. The system of claim 1, wherein the second scale represents the depth of pain on a gray scale from the corresponding gray shade white for superficial pain to the corresponding gray shade black for deep pain, and corresponds to the second numeric scale of zero to one hundred, respectively.

4. The system of claim 1, wherein indicating the area of the human body replica representing the pain area comprises identifying a center of pain.

5. The system of claim 1, wherein displaying the objective pain value further comprises displaying at least one of the pain area, the pain intensity, and the depth of pain.

6. The system of claim 1, further comprising offering an option to complete a customized pain survey.

7. The system of claim 1, further comprising offering an option to choose an additional pain area to indicate and describe.

8. A method of computerized pain assessment, comprising:
displaying a screen that includes human body replica containing a known number of pixels;
indicating an area of the human body replica representing a pain area, wherein a indicated number of pixels of the area of the human body replica representing the pain area divided by the known number of pixels in the human body replica defines a pain coverage;
indicating a depth of pain on a scale depicting the depth of pain, wherein the scale corresponds to a numeric scale for measuring the depth of pain;
computing an objective pain value from the pain coverage multiplied by the depth of pain intensity on the numeric scale; and
displaying the objective pain value.

9. The method of claim 8, wherein the scale represents the depth of pain on a gray scale from the corresponding gray shade white for superficial pain to the corresponding gray shade black for deep pain, and corresponds to the numeric scale of zero to one hundred, respectively

10. The method of claim 8, wherein indicating the area of the human body replica representing the pain area comprises identifying a center of pain

11. The method of claim 1, wherein displaying the objective pain value further comprises displaying at least one of the pain area, the pain intensity, and the depth of pain.

12. The method of claim 8, further comprising offering an option to complete a customized pain survey.

13. The method of claim 8, further comprising offering an option to choose an additional pain area to indicate and describe.

14. A non-transitory computer readable medium including computer executable program instructions for computerized pain assessment, the program instructions including instructions to:
displaying a screen that includes a human body replica containing a known number of pixels;
indicating an area of the human body replica to represent a pain area, wherein an indicated number of pixels of the area of the human body replica representing the pain area divided by the known number of pixels in the human body replica defines a pain coverage;
indicating a pain intensity on a first scale depicting the pain intensity between minimum pain and maximum pain, wherein the first scale corresponds to a first numeric scale for measuring the pain intensity;
indicating a depth of pain on a second scale depicting the depth of pain, wherein the second scale corresponds to a second numeric scale for measuring the depth of pain;
computing an objective pain value from the pain intensity on the numeric scale multiplied by the depth of pain on the second numeric scale; and
displaying the pain coverage and the objective pain value.

15. The non-transitory computer readable medium of claim 14, wherein the first scale represents the pain intensity on a color spectrum scale from blue to red, and corresponds to the first numeric scale of zero to one hundred, respectively

16. The non-transitory computer readable medium of claim 14, wherein the second scale represents the depth of pain on a gray scale from the corresponding gray shade white for superficial pain to the corresponding gray shade black for deep pain, and corresponds to the second numeric scale of zero to one hundred, respectively

17. The non-transitory computer readable medium of claim 14, wherein indicating the area of the human body replica representing the pain area comprises identifying a center of pain.

18. The non-transitory computer readable medium of claim 14, wherein displaying the objective pain value further comprises displaying at least one of the pain intensity and the depth of pain.

19. The non-transitory computer readable medium of claim 14, further comprising offering an option to complete a customized pain survey.

20. The non-transitory computer readable medium of claim 14, further comprising offering an option to choose an additional pain area to indicate and describe.
